(19) United States
(12) Patent Application Publication
(10) Pub. No.: US 2002/0069541 A1
(43) Pub. Date: Jun. 13, 2002

(54) Trim installation tool and method

(76) Inventor: Melvin W. Sumner, Ottawa, KS (US)

Correspondence Address: Shughart Thomson & Kilroy, P.C., Twelve Wyandotte Plaza, 120 West 12th Street, Kansas City, MO, 64105, US

(21) Appl. No.: 09/735,386

(22) Filed: Dec. 12, 2000

(51) Int. Cl. G01C 9/00

(52) U.S. Cl. 33/194; 33/371

(57) ABSTRACT

A trim installation tool includes a base with first and second ends, inner and outer faces, and opposite side edges. First and second clamp assemblies are mounted on the base in proximity to its first and second ends respectively. The clamp assemblies have engaged and disengaged positions for respectively clamping and releasing a wall edge adjacent to the wall opening. An elongated level with an orientation-display device is mounted on the base inner face and extends generally between the ends thereof. The orientation-display device indicates a level or plumb orientation of a trim piece clamped in position by the tool for attachment to the frame members surrounding the wall opening.

### BACKGROUND OF THE INVENTION

1. Field of the Invention

The present invention relates generally to clamping and leveling tools and procedures, and in particular to a cased opening trim installation tool and method.

2. Description of the Related Art

In construction, wall openings are commonly formed for various purposes, e.g. to accommodate doors and windows. Sometimes wall openings are formed and left open to provide relatively free access between adjacent rooms in a structure. A relatively large number of interior partitions in residential and commercial construction are assembled in this manner. Many interior residential partitions have overall thicknesses of about 4-½ inches. One of the advantages of having relatively uniform-thickness partitions is that sizes of millwork for trimming same can be relatively uniform and standardized. Such standardization can be desirable because of the efficiencies involved in utilizing common trim sizes which are sized for the most popular wall thicknesses.

Such openings are often edged with trim pieces to conceal the framing members which surround and frame the opening, and also to provide a finished, aesthetically pleasing appearance which can be relatively uniform throughout the structure. A typical opening trim system might include, for example, a pair of jamb trim pieces each mounted on a respective side of the opening on a respective framing member framing same, a header or transom trim piece mounted on the underside of a header assembly constructed of structural framing members, and casing trim consisting of both jamb and header casing trim pieces for mounting on the wall faces on both sides around the opening. Additional trim pieces can be added, e.g., door stops for door openings, etc.

The widths of wall openings encountered in constructions vary considerably, but headers are normally placed at about 6′-8″ to 7′ above the floor, whereby standard doors with heights in the range of about 6′-8″ to 7′ can be accommodated. Since the trim around such an opening is typically a conspicuously visible part of the finished building interior, relatively precise installation can be highly desirable. However, rough-in or frame carpentry can be relatively inaccurate, with the framing lumber bordering the opening being somewhat out-of-plumb, out-of-square, etc.

To accommodate for such inaccuracies, the opening trim pieces are often carefully positioned within the wall openings to provide same with square and plumb configurations. The fine positioning of the jamb and header trim pieces can be accomplished with wedge-shaped shims inserted between the trim pieces and the opening framing members. The relative spacing between the trim pieces and the opening framing members can be adjusted by varying the number of shims and their thicknesses. However, such procedures tend to be relatively time consuming and awkward, particularly for unassisted workers. Difficulties can be encountered in installing such trim pieces in a square, plumb manner, particularly with respect to temporarily positioning the shims and casing trim pieces for nailing. During nailing, the shims and the trim pieces can shift, causing misalignment. Such problems can be compounded when a door is hingedly mounted on one of the jamb trim pieces.

Therefore, conventional methods of installing cased opening trim pieces tended to produce results which were sometimes lacking in uniformity and neatness of appearance.

Certain types of construction, particularly commercial and institutional facilities, involve the use of steel door frames and steel studs in lieu of wood, which is commonly used in residential construction. Steel door frames are often prefabricated for placement in the wall openings prior to installing the wall panels. It is desirable for such door frame assemblies to be properly positioned when fastened to the wall structures in which they are mounted.

A previous solution to the problem of positioning and holding trim in door and window openings during installation utilized a tool with a level adapted for mounting in an opening with set screws. With the installation tool in place, the jam and header trim could be properly positioned and nailed in place. However, the set screws used for attaching the tool tended to slow installation and removal. Moreover, the previous tool did not accommodate standard, commercially-available levels and was not readily adjustable for various wall thicknesses.

The present invention addresses the aforementioned problems with previous equipment and techniques for trimming wall openings.

### SUMMARY OF THE INVENTION

In the practice of the present invention, a trim installation tool is provided which includes a base having first and second ends, inner and outer faces, and opposite side edges. First and second clamp assemblies are mounted on the base first and second ends respectively. Each clamp assembly includes first and second clamp brackets connected by a bridge. Each first clamp bracket mounts a toggle clamp with an over-center plunger mechanism. The clamp assemblies have engaged positions adapted for engaging a wall and disengaged positions disengaged therefrom. An elongated level with orientation-display assemblies is mounted on the base inner face and extends generally between the ends thereof Optional spacers are provided for spacing the base to provide clearance for a door trim piece.

### OBJECTS AND ADVANTAGES OF THE INVENTION

The principle objects and advantages of the present invention include: providing a wall opening trim installation tool; providing such a tool which is adapted for installing trim in a relatively square and plumb configuration; providing such a tool which is adapted for installing trim around various types of openings including door openings, clear openings and window openings in walls; providing such a tool which facilitates installing trim by a single worker; providing such a tool which can be adjusted for various wall thicknesses; providing such a tool which provides relatively accurate placement for trim systems in wall openings of various sizes; providing such a tool which is adapted for firmly clamping casing trim in place prior to being permanently nailed; providing such a tool which accommodates nailing of casing trim permanently in place with nail guns and the like; providing such a tool which utilizes commercially-available levels; and providing such a tool which is economical to manufacture, efficient in operation, capable of a long operating life, designed for fabrication from common materials and components, and which is particularly well adapted for the proposed usage thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of a wall with an opening and a trim installation tool embodying the present invention clamped to the wall at a side edge of the opening.

FIG. 2 is a cross-sectional view of the trim installation tool and the wall opening side edge, taking generally along line 2-2 in FIG. 1.

FIG. 3 is a cross-sectional view of the trim installation tool with a clamp assembly thereof in a disengaged position.

FIG. 4 is a fragmentary, enlarged, side elevational view of the trim installation tool, particularly showing a bubble-type orientation-display assembly thereof

FIG. 5 is a cross-sectional view of a trimmed edge of the door opening.

FIG. 6 is a cross-sectional view of a trim installation tool fitted with optional spacers for clearing a door stop trim piece.

### DETAILED DESCRIPTION OF THE PREFERRED EMBODIMENTS

As required, detailed embodiments of the present invention are disclosed herein;

however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

I. Introduction and Environment

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

Referring to the drawings in more detail, the reference numeral 10 generally designates a trim installation tool. Without limitation on the generality of useful applications of the present invention, the trim installation tool 10 can be utilized for installing a trim system 12 on a wall 20 for finishing or casing a wall opening 18 formed therein with a pair of oppositely-disposed, vertical, jamb edges 15 and a horizontally-disposed head or transom edge 17.

The wall 20 can comprise a conventional wall construction with studs 28 extending vertically in spaced relation (e.g., at 16″ or 24″ on centers) between wall panels 30. The wall panels 30 can comprise a variety of materials, such as gypsum board, plywood, particle board, etc. A header 31 extends across the top of the wall opening 18 and includes a header plate 32 positioned adjacent to the opening head or transom edge 17 between the wall panels 30. A pair of cripples or trimmers 33 support the header 31; each cripple or trimmer 33 is placed adjacent to a respective wall jamb or side edge 15 between the wall panels 30. The header plate 32 and the trimmers 33 can comprise common framing lumber, such as 2×4's with actual cross-sectional dimensions of about 1-½″ thick by about 3-½″ wide.

The wall panels 30 can have thicknesses of, for example, approximately ½ inches each whereby the overall wall thickness would be approximately 4-½″. However, structural members 28, 31, 32 and 33 with other dimensions, and wall panels 30 with other thicknesses, can be accommodated with the trim installation tool 10 of the present invention.

The wall 20 described thus far is of generally conventional construction. For aesthetic purposes, the edges 15 and 17 which form the wall opening 18 can be covered by the casing trim system 12 to provide a cased wall opening 18.

The casing trim system 12 can comprise a pair of side or jamb trim pieces 22 and a head or transom trim piece 24, which can be attached to the trimmers 33 and the header plate 32 respectively, e.g., by nailing, with shims 25 installed therebetween for proper positioning. Side and top casing trim pieces 26, 27 are applied to the jamb and head trim pieces 22, 24 and to the trimmers 33 and the header plate 32 through the panels 30. The casing trim pieces 26, 27 thus overlap the panels 30 slightly to conceal the unfinished edges thereof The tool 10 generally comprises a base 40, a pair of clamp assemblies 42, and a level 44.

II Base 40

The base 40 includes first and second ends 45, 46 and a rectangular cross-sectional configuration. The base 40 further includes an outer, contact or trim engagement face 37, and an inner face 38. The base 40 has a pair of side edges 49 and a plurality of nailing holes 43.

III. Clamp Assemblies 42

Each clamp assembly 42 is mounted on the base inner face 38 in proximity to a respective end 45, 46 and includes first and second clamp brackets 52a,b. Each bracket 52a,b includes a respective base leg 54a,b mounted on the base inner face 38 and projecting laterally from a respective base side edge 49. Each bracket 52a,b also includes an extension leg 56a,b extending outwardly from a respective base leg 54a,b. Each first clamp bracket 52a includes a toggle clamp 58 with an over-center plunger mechanism 60 with retracted and extended positions. A handle 62 is provided for moving the toggle clamp 58 between its retracted and extended positions. A foot 64 is mounted on the end of the plunger mechanism 60 by a threaded shaft 61 with a set nut 63 in spaced relation from and parallel to the first extension leg 56a. A clearance 78 is defined between the foot 64 and the second extension leg 56b for receiving the wall 20 adjacent to the wall opening 18. Each clamp assembly 42 also includes a bridge 66 connected to and extending between the base legs 54a,b for securing same together in fixed relation corresponding to the thickness of the wall 20.

The toggle clamp 58 can be adjusted to accommodate different wall thicknesses by threadably retracting and extending the foot 64 on the shaft 61. Alternatively, greater variations in wall thickness can be accommodated by providing different clamp brackets 52 with various spacings between their respective extension legs 56a,b. For example, wall thicknesses can vary considerably depending upon their construction with studs of different widths. Stud widths varying from 1½ inches to 7½ inches are common. Clamp brackets 52a,b for various wall thicknesses can be provided for interchangeably mounting on the base 40 as needed.

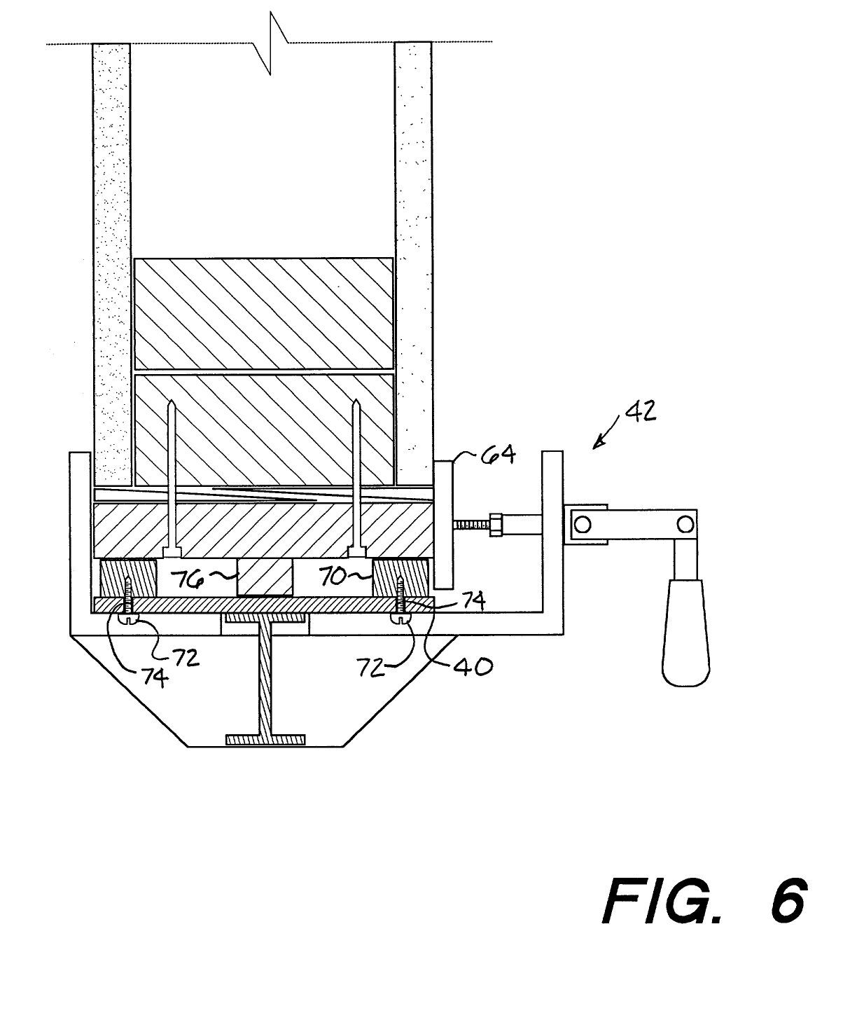

FIG. 6 shows an optional configuration of the tool 10 with spacers 70 mounted on the base outer face 37 by screws 72 extending through receivers 74 formed in the base 40 at regular intervals. The spacers 70 space the base 40 inwardly from the trim pieces 22, 24 to clear a door stop trim piece 76. It will be appreciated that the spacers 70 can easily be installed and removed as needed, and different thicknesses of spacers can be provided to provide clearance for different thicknesses of door stop trim pieces 76.

IV. Level 44

The level 44 includes a total of three orientation-display assemblies; two end display assemblies 102 and a middle orientation display assembly 104 mounted in the level 44. Each display assembly 102, 104 includes a liquid-filled tube 106 with a bubble 108, the tube 106 being mounted in an annular rum 110 and extending more or less diametrically thereacross. The rims 110 can be rotatable for reorienting the tubes 106.

The level 44 can comprise a standard, commercially-available level of the type commonly used in construction. The overall length should preferably be under six feet in order to fit within commonly-encountered door openings. Shorter-length levels can be utilized for mounting head/transom trim pieces 24, for trimming window openings, etc.

V. Operation and Trim Installation Method

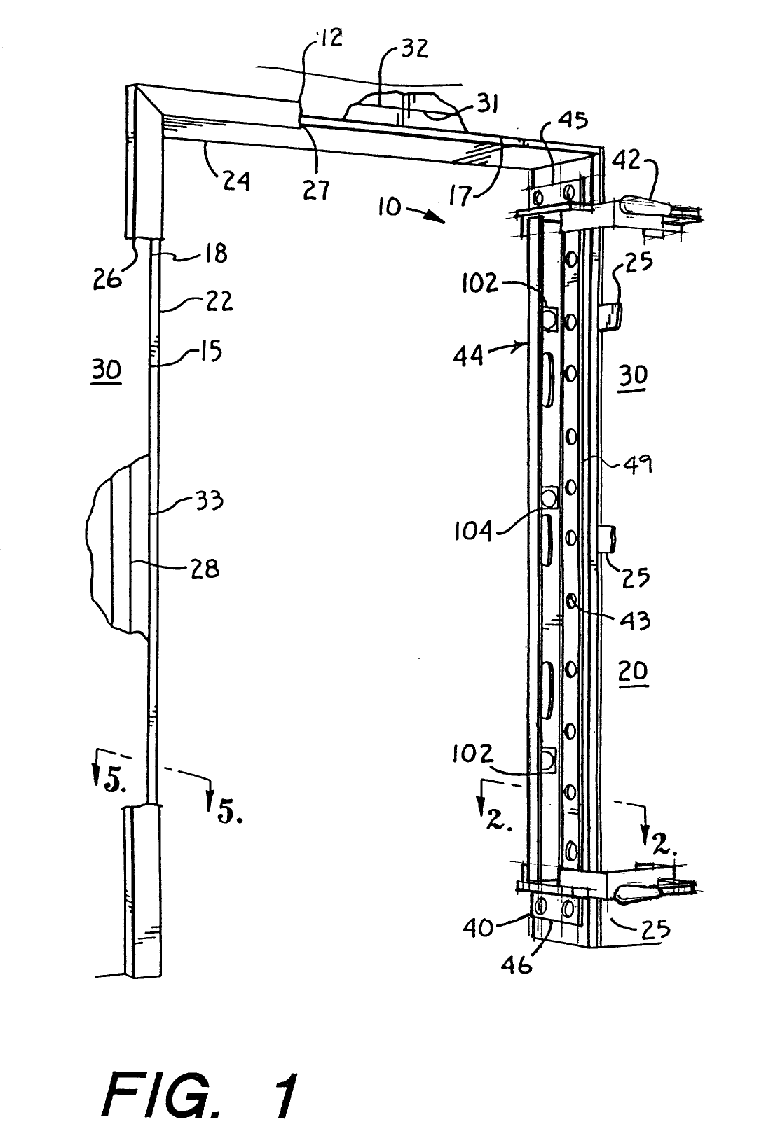

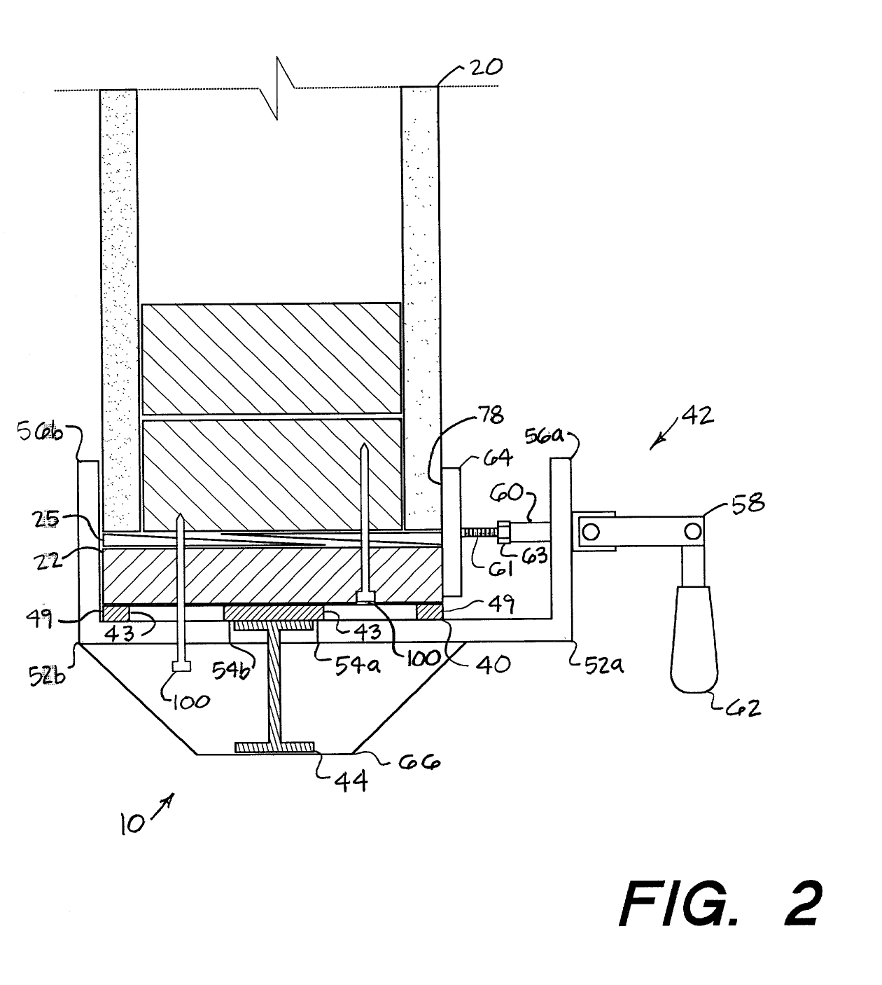

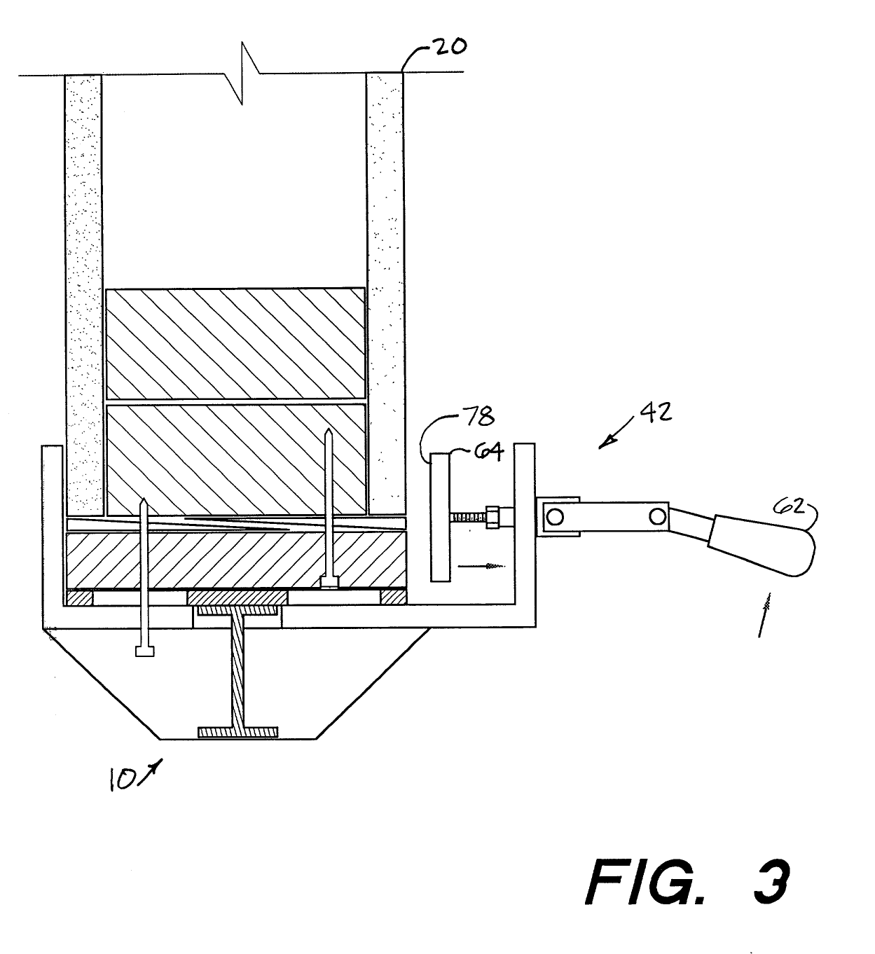

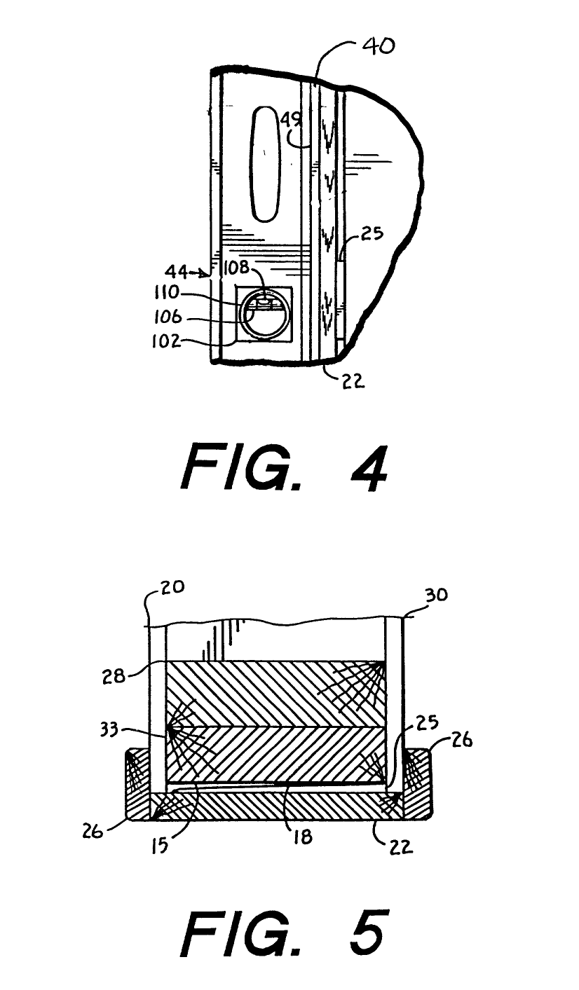

In operation, the tool 10 can be used for placing a variety of members and holding them in predetermined positions. The level 44 can provide the user with a relatively accurate indication of the orientation of a member clamped by the tool 10. For example, the tubes 106 can be placed in longitudinal alignment with the tool 10 for indicating the horizontal orientation of the tool 10 and a horizontal member (e.g., head or transom trim piece 24) clamped thereby, or can be oriented substantially transversely with respect to the tool 10 for indicating a vertical orientation of the tool 10 and a vertical member (e.g., side or jamb trim piece 22) clamped thereby. The end orientation-display assemblies 102, 104, with their tubes 106 oriented substantially transversely to the tool 10, can be positioned near the top and bottom of the wall opening 18 (FIG. 1) for reference by a worker in proximity to the clamp assemblies 42.

The clamp assembly clearances 78 receive the wall 20 and can be closed by the feet 64. The nailing holes 43 provide openings for nails 100 or other fasteners to be driven through the respective trim pieces 22, 24 and into respective framing members such as the header plate 32 and the trimmers 33. Pneumatic nail guns could be employed for nailing the trim pieces 22, 24 in place through the nailing holes 43.

It is to be understood that while certain forms of the present invention have been illustrated and described herein, it is not to be limited to the specific forms or arrangement of parts described and shown.

What is claimed and desired to be secured by letters patent is as follows:

1. A wall opening trim installation tool, which comprises:
(a) an elongated base with first and second ends, an outer trim engagement face, an inner face and a pair of opposite side edges;
(b) a clamp assembly including first and second brackets mounted on said base and projecting laterally and outwardly therefrom, said clamp assembly including a toggle clamp with engaged and disengaged positions with respect to said wall; and
(c) an elongated level mounted on said base and including an orientation-display assembly.

2. The tool according to claim 1, which includes:
(a) said clamp assembly including a foot located between said brackets and movable between an engaged position engaging said wall with said clamp assembly in its extended position and a disengaged position disengaged from said wall with said clamp assembly in its retracted positioned.

3. The tool according to claim 1, which includes a plurality of spacers mounted on said base outer face.

4. The tool according to claim 1 wherein said base includes a line of openings extending in generally parallel relation with respect to said base side edges.

5. The tool according to claim 4 wherein said line of openings comprises a first line of openings adjacent to one of said edges, and wherein said base includes a second line of openings in spaced relation from and generally parallel to said other base side edge.

6. The tool according to claim 1 wherein each said clamp assembly bracket includes a base leg mounted on said base and projecting laterally therefrom and an extension leg extending outwardly from said base leg.

7. The tool according to claim 6, which includes a respective clearance formed between said extension legs of each clamp assembly, said clearance receiving said wall adjacent to said opening.

8. The tool according to claim 7 wherein each said toggle clamp is mounted on a respective extension leg.

9. The tool according to claim 8 wherein each said toggle clamp mounts a foot located in said clearance and each said foot grippingly engages said wall with said toggle clamp in its extended position.

10. A tool for installing trim in an opening in a wall including opposite wall opening side edges and a wall opening header edge; which comprises:
(a) a base with opposite ends, opposite first and second side edges, an outer/engagement face, an inner face, first and second lines of spaced openings extending parallel to and spaced inwardly from the first and second side edges respectively and a plurality of spaced screw receivers located in proximity to said base side edges;
(b) a pair of clamp assemblies each located in proximity to a respective base and including:
1) first and second brackets including first and second base legs respectively mounted on said base inner face and projecting laterally from said base first and second edges respectively and first and second extension legs each extending outwardly from a respective base leg and projecting outwardly beyond said base outer face;
2) a clamp assembly clearance located between said first and second extension legs and adapted to receive said wall adjacent to said opening therein;
3) a toggle clamp mounted on sad first extension leg and including an over-center plunger mechanism movable between retracted and extended positions with respect to said first extension leg, said clamp including a handle mounted outside said first extension leg and adapted for moving said plunger mechanism between its retracted and extended positions, each said clamp including a foot mounted on said plunger mechanism and adapted for engaging said wall with said plunger mechanism in its extended position and retracted from said wall with said plunger mechanism in its retracted position; and
4) a bridge extending between and connected to said first and second legs and located in proximity to a respective level end;
(c) an elongated level with first and second ends, said level being mounted on said base inner face with its first and second ends located in proximity to said base first and second ends respectively, said level including first and second end orientation-display assemblies each located in proximity to a respective level end and a medial orientation-display assembly located intermediate said first and second end orientation-display assemblies; and
(d) each said orientation-display assembly including a liquid-filled tube with a bubble.
